(19) United States
(12) Patent Application Publication
(10) Pub. No.: US 2004/0254854 A1
(43) Pub. Date: Dec. 16, 2004

(54) Purchase management system and method

(76) Inventors: Sun-Chang Lin, Tu-Chen (TW); Shu-Ming Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/867,982

(22) Filed: Jun. 14, 2004

(30) Foreign Application Priority Data
Jun. 13, 2003 (TW) 92116174

(51) Int. Cl. G06F 17/60

(52) U.S. Cl. 705/26

(57) ABSTRACT

A purchase management system includes a buyer server (12), a database (14), and a number of client computers (10) and vendor servers (15). The database stores electronic documents including price inquiry sheets, quotations, purchase orders, delivery notices, reminder letters, overdue delivery notices, and receipt notices. The client computers provide interfaces for various departments to submit respective purchase requisitions, and for purchasing operators to maintain information stored in the database. The vendor servers receive electronic documents from the buyer server, and transmit quotations to the buyer server. The buyer server is provided with a number of software modules for processing of purchase and delivery arrangements, including a delivery managing module (24). The delivery managing module includes an on schedule delivery managing sub-module (241); and an overdue delivery managing sub-module (242) for generating reminder letters and overdue delivery notices, and transmitting the reminder letters and overdue delivery notices to corresponding vendors.

### BACKGROUND OF THE INVENTION

1. Field of the Invention

The present invention relates to computerized purchase management systems and methods, and particularly to a purchase management system and method which can electronically process delivery arrangements for a purchasing organization and its corresponding vendors.

2. Background of the Invention

Traditional computerized systems for purchase management pay much attention to monitoring goods delivered by vendors, and neglect to properly manage an overdue delivery according to its scheduled delivery date. A conventional method for purchase management is disclosed in U.S. Pat. No. 6,560,645, issued on May 6, 2003 and entitled Delivery Schedule Management Method, Apparatus for Implementing the Method, Processing Program Thereof and Medium Having the Program Recorded Therein. The patent discloses a delivery schedule management method, which manages delivery schedules of delivery data in an electronic data distribution system. The system connects a delivery data server for inputting the delivery data, a digitization server for digitizing the delivery data, a storage and management server for storing and managing electronic delivery data, a delivery management server for managing delivery of the electronic delivery data, and an electronic user terminal for receiving delivered electronic data and transmitting received electronic data through a network. A disadvantage of the above described system is that it does not adequately deal with the problem of controlling overdue deliveries by vendors, which can lead to a manufacturer suffering great loss if it is not able to timely fulfill customer orders.

### SUMMARY OF THE INVENTION

A main objective of the present invention is to provide a purchase management system which can electronically process both timely and untimely delivery arrangements for a purchasing organization and its corresponding vendors.

Another objective of the present invention is to provide a purchase management method which can electronically process both timely and untimely delivery arrangements for a purchasing organization and its corresponding vendors.

To achieve the first above-mentioned objective, a preferred embodiment of a purchase management system in accordance with the present invention comprises a buyer server, a database linked to the buyer server, and a plurality of client computers and vendor servers connected with the buyer server through a network. The database stores electronic documents used or generated by the system. The client computers provide user interfaces for departments of a purchasing organization to submit respective purchase requisitions, and for purchasing operators to maintaining the electronic documents in the database. The vendor servers receive electronic documents from the buyer server, and transmit quotations to the buyer server according to received price inquiry sheets.

The buyer server comprises: a purchase managing module for negotiating prices online with vendors running the vendor servers, selecting one or more suitable vendors, and signing a purchase contract online with each selected vendor; a goods receiving module for generating a receipt notice when the purchased goods have been checked and accepted by the purchasing organization; and a delivery managing module for processing delivery arrangements. The delivery managing module comprises: an on schedule delivery managing sub-module for transmitting a delivery notice to each selected vendor, and processing on schedule delivery arrangements; and an overdue delivery managing sub-module for generating a reminder letter and transmitting the reminder letter to a selected vendor if the selected vendor fails to deliver purchased goods on schedule, and generating an overdue delivery notice and transmitting the overdue delivery notice to the selected vendor when the vendor delivers the purchased goods.

To achieve the second above-mentioned objective, a preferred purchase management method in accordance with the present invention comprises the following steps: receiving purchase requisitions from departments of a purchasing organization; creating price inquiry sheets according to the purchase requisitions, and transmitting the price inquiry sheets to corresponding vendors; receiving quotations from the vendors; determining one or more suitable vendors according to the quotations; creating a purchase order for each selected vendor; determining whether a vendor delivers purchased goods on schedule; transmitting a reminder letter to the vendor if the vendor fails to deliver the purchased goods on schedule; and transmitting an overdue delivery notice to the vendor after the vendor delivers the purchased goods.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of hardware configuration of a purchase management system in accordance with the preferred embodiment of the present invention;

FIG. 2 is a schematic diagram of function modules of a buyer server of the system of FIG. 1; and

FIG. 3 is a flowchart of a preferred method for purchase management according to the present invention.

### DETAILED DESCRIPTION OF THE INVENTION

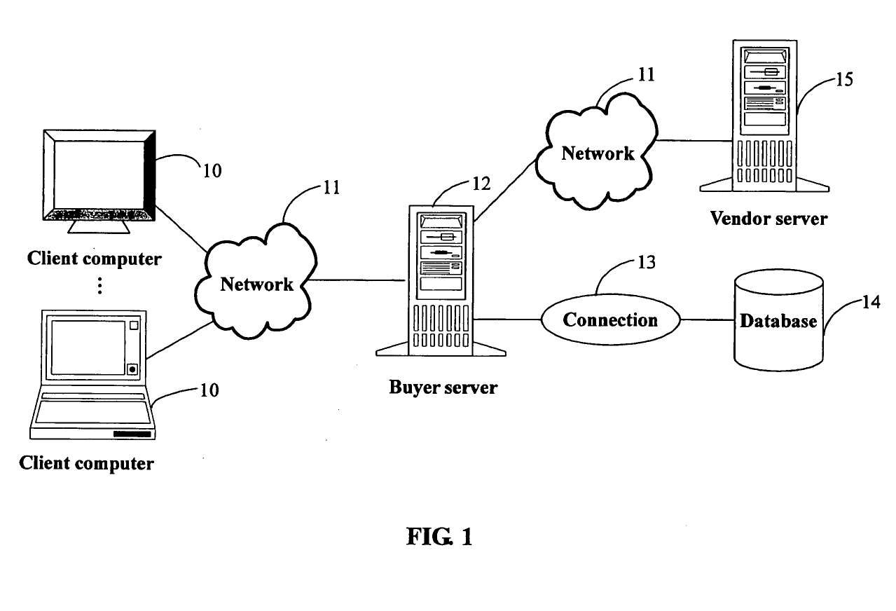

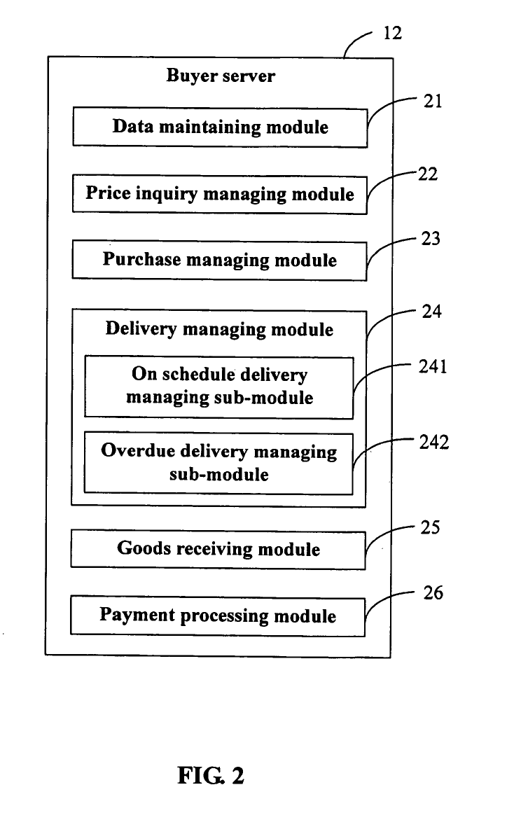

FIG. 1 is a schematic diagram of hardware configuration of a purchase management system in accordance with the preferred embodiment of the present invention. The purchase management system is run by a purchasing organization, and comprises a plurality of client computers 10, a buyer server 12, a database 14, and a plurality of vendor servers 15 (only one shown). The client computers 10 and the vendor servers 15 communicate with the buyer server 12 via a network 11. The network 11 can jointly or severally be the Internet, an intranet, or another suitable means of electronic communication. The buyer server 12 is connected to the database 14 via a connection 13. The connection 13 is a kind of database connection, which can be an Open Database Connectivity (ODBC), a Java Database Connectivity (JDBC) or another suitable kind of connectivity. The buyer server 12 has a plurality of software modules installed therein, respectively for accomplishing one or more particular functions. (The software modules and their functions are described in detail below in relation to FIG. 2.) The database 14 stores electronic documents used or generated by the purchase management system. The electronic documents comprise purchase requisitions, price inquiry sheets, quotations, purchase orders, delivery notices, reminder letters, overdue delivery notices, and receipt notices. The client computers 10 provide user interfaces for various departments of the purchasing organization to submit their purchase requisitions, and for purchasing operators to maintain the electronic documents stored in the database 14. Each vendor server 15 is run by a corresponding vendor. The vendor server 15 receives electronic documents including price inquiry sheets from the buyer server 12, and transmits quotations to the buyer server 12 according to the received price inquiry sheets.

FIG. 2 is a schematic diagram of function modules of the buyer server 12. The buyer server 12 comprises a data maintaining module 21, a price inquiry managing module 22, a purchase managing module 23, a delivery managing module 24, a goods receiving module 25, and a payment processing module 26.

The data maintaining module 21 is used for maintaining electronic documents stored in the database 14. Such maintenance comprises adding, editing, modifying, and deleting information of the electronic documents.

The price inquiry managing module 22 is provided for creating price inquiry sheets according to purchase requisitions submitted by departments of the purchasing organization, and transmitting the price inquiry sheets to corresponding vendor servers 15 via the network 11. Then the price inquiry managing module 22 receives quotations offered by the vendors running the vendor servers 15, and stores the quotations in the database 14.

The purchase managing module 23 is used for negotiating prices online with the vendors, selecting one or more suitable vendors according to their quotations, and signing a purchase contract online with each selected vendor.

The delivery managing module 24 is used for processing delivery arrangements, and comprises an on schedule delivery managing sub-module 241 and an overdue delivery managing sub-module 242. The on schedule delivery managing sub-module 241 transmits a delivery notice to each selected vendor. The delivery notice typically defines a scheduled delivery date, a delivery destination, and names, quantities and specifications of purchased goods. Then the on schedule delivery managing sub-module 241 processes subsequent delivery arrangements if the selected vendor delivers the purchased goods on schedule. However, if any selected vendor fails to deliver the purchased goods on schedule, the overdue delivery managing sub-module 242 generates a reminder letter, and transmits the reminder letter to the vendor server 15 run by the vendor. The reminder letter specifies a new delivery date, and requires the vendor to deliver the purchased goods on or before that date. After the purchasing organization receives the purchased goods, the overdue delivery managing sub-module 242 generates an overdue delivery notice, and transmits the overdue delivery notice to the vendor server 15. The overdue delivery notice generally comprises a number of a corresponding purchase order, a scheduled delivery date, an actual delivery date, a total amount of the purchase order, and an actual payment for the purchase order. As a penalty for overdue delivery, the actual payment for the purchase order may be less than the total amount of the purchase order.

The goods receiving module 25 is provided for generating a receipt notice when purchased goods have been checked and accepted by the purchasing organization, and transmitting the receipt notice to the corresponding vendor server 15. The receipt notice typically comprises a number of the purchase order, a receipt date, and a catalog of the purchased goods.

The payment processing module 26 is used for reconciling accounts after a purchase transaction is ended, and apportioning costs and expenses to the departments of the purchasing organization according to their respective purchase requisitions.

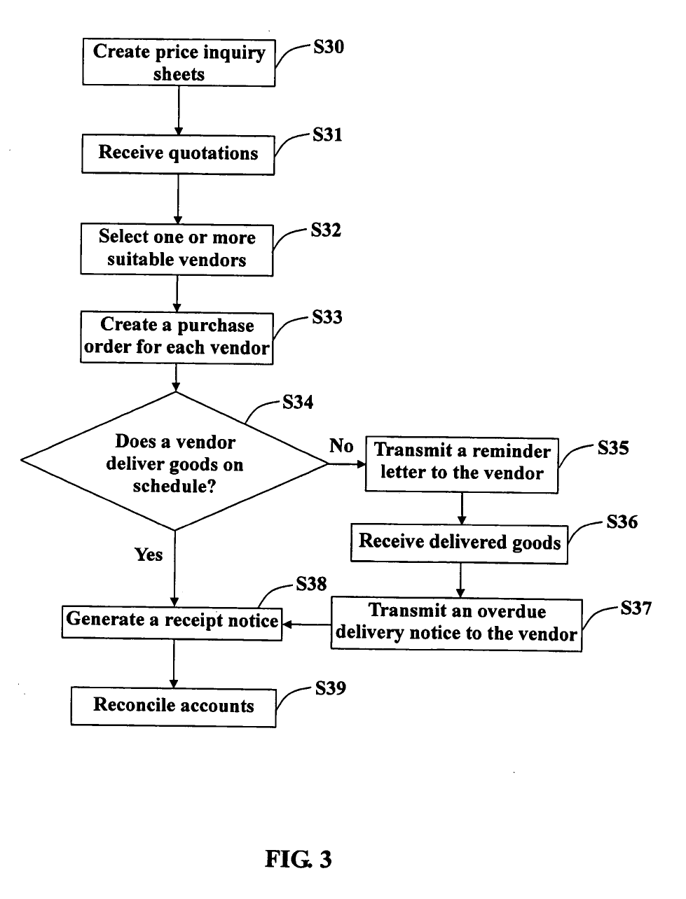

FIG. 3 is a flowchart of a preferred method for purchase management according to the present invention, utilizing the above-described purchase management system. In step S30, the buyer server 12 receives purchase requisitions submitted by various departments of the purchasing organization from the client computers 10. The price inquiry managing module 22 creates price inquiry sheets according to the purchase requisitions, and transmits the price inquiry sheets to corresponding vendors providing the purchased goods. In step S31, the buyer server 12 receives quotations from the vendor servers 15 run by the vendors. In step S32, the purchase managing module 23 selects one or more suitable vendors according to the quotations of the vendors. In step S33, the purchase managing module 23 creates a purchase order for each selected vendor according to the purchase requisitions, and transmits the purchase order to each vendor server 15 run by each selected vendor via the network 11. In step S34, the buyer server 12 determines whether a selected vendor delivers the purchased goods on schedule by comparing an actual delivery date by the vendor with a scheduled delivery date. If the vendor delivers the goods on schedule, the procedure goes directly to step S38 described below. If the vendor fails to deliver the purchased goods on schedule, in step S35, the buyer server 12 generates a reminder letter, and transmits the reminder letter to the vendor server 15. In step S36, the buyer server 12 receives the goods delivered by the vendor. In step S37, the buyer server 12 generates an overdue delivery notice, and transmits the overdue delivery notice to the vendor server 15. In step S38, operators of the purchasing organization check the delivered goods according to the purchase requisitions. The goods receiving module 25 generates a receipt notice if the delivered goods are satisfactory, and transmits the receipt notice to the vendor server 15. In step S39, the payment processing module reconciles corresponding accounts, and apportions purchase costs and expenses to the purchasing departments of the purchasing organization according to their respective purchase requisitions.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A network-based purchase management system for electronically processing delivery arrangements for a purchasing organization and corresponding vendors, the system comprising a buyer server, a database linked to the buyer server, and one or more client computers and vendor servers connected with the buyer server through a communications network, wherein:
the database stores electronic documents used or generated by the system;
said client computers provide user interfaces for departments of the purchasing organization to submit respective purchase requisitions, and for purchasing operators to maintain electronic documents in the database;
said vendor servers receive one or more electronic documents comprising one or more price inquiry sheets from the buyer server, and transmit quotations to the buyer server according to said received price inquiry sheets; and
the buyer server comprises:
a purchase managing module for negotiating prices online with the vendors running said vendor servers, selecting one or more suitable vendors, and signing a purchase contract online with each of said selected vendors;
a delivery managing module for processing delivery arrangements, comprising:
an on schedule delivery managing sub-module for transmitting a delivery notice to each of said selected vendors, and processing on schedule delivery arrangements; and
an overdue delivery managing sub-module for generating a reminder letter and transmitting the reminder letter to a selected vendor if the selected vendor fails to deliver purchased goods on schedule, and generating an overdue delivery notice and transmitting the overdue delivery notice to the selected vendor when the vendor delivers the purchased goods; and
a goods receiving module for generating a receipt notice when the purchased goods have been checked and accepted by the purchasing organization.

2. The system as described in claim 1, wherein the buyer server further comprises a data maintaining module for maintaining the electronic documents stored in the database.

3. The system as described in claim 1, wherein the buyer server further comprises a price inquiry managing module for creating one or more price inquiry sheets according to the purchase requisitions, and transmitting said price inquiry sheets to said vendor servers.

4. The system as described in claim 1, wherein the buyer server further comprises a payment processing module for reconciling accounts after the purchased goods have been checked and accepted by the purchasing organization.

5. The system as described in claim 1, wherein the delivery notice comprises a delivery date, a delivery destination, and names, quantities and specifications of the purchased goods.

6. The system as described in claim 1, wherein the reminder notice defines a new delivery date which requires the vendor to deliver the purchased goods on or before that date.

7. The system as described in claim 1, wherein the overdue delivery notice comprises a number of a corresponding purchase order, a scheduled delivery date, an actual delivery date, a total amount of the purchase order, and an actual payment for the purchase order.

8. A network-based purchase management method for electronically processing delivery arrangements for a purchasing organization and corresponding vendors, the method comprising the steps of:
receiving purchase requisitions from one or more departments of the purchasing organization;
creating price inquiry sheets according to the purchase requisitions, and transmitting the price inquiry sheets to the corresponding vendors;
receiving quotations from the vendors;
selecting one or more suitable vendors according to the quotations;
creating a purchase order for each of the selected vendors;
determining whether a vendor delivers purchased goods on schedule;
transmitting a reminder letter to the vendor if the vendor fails to deliver the purchased goods on schedule; and
transmitting an overdue delivery notice to the vendor after the vendor delivers the purchased goods.

9. The method as described in claim 8, further comprising the step of checking the purchased goods and accepting the purchased goods if they are satisfactory.

10. The method as described in claim 8, further comprising the step of reconciling corresponding accounts and apportioning purchase costs and expenses to said departments according to the purchase requisitions.

11. A network-based purchase management method for electronically processing delivery arrangements for a purchasing organization and corresponding vendors, the method comprising the steps of:
(a) receiving purchase requisitions from one or more departments of the purchasing organization;
(b) creating price inquiry sheets according to the purchase requisitions, and transmitting the price inquiry sheets to the corresponding vendors;
(c) receiving quotations from the vendors;
(d) selecting one or more suitable vendors according to the quotations;
(e) creating a purchase order for each of the selected vendors;
(f) determining whether a vendor delivers purchased goods on schedule; and
(g) generating a receipt notice if yes for step (f).
